(19) United States
(12) Patent Application Publication
(10) Pub. No.: US 2014/0209517 A1
(43) Pub. Date: Jul. 31, 2014

(54) DISPERSION NOZZLE, FLOTATION MACHINE EQUIPPED THEREWITH, AND METHOD FOR OPERATING SAME

(71) Applicant: SIEMENS AKTIENGESELLSCHAFT, Munchen (DE)

(72) Inventors: Stefan Blendinger, Furth (DE); Robert Fleck, Adelsdorf (DE); Gerold Franke, Nürnberg (DE); Lilla Grossmann, Erlangen (DE); Werner Hartmann, Weisendorf (DE); Wolfgang Krieglstein, Nürnberg (DE)

(21) Appl. No.: 14/346,827

(22) PCT Filed: Aug. 30, 2012
(86) PCT No.: PCT/EP2012/066836

§ 371 Date: Mar. 24, 2014

(30) Foreign Application Priority Data
Sep. 23, 2011 (EP) 11182473.6

(51) Int. Cl. B03D 1/24; B03D 1/02

(52) U.S. Cl. CPC B03D 1/242; B03D 1/02
USPC 209/164; 239/417.5; 239/8; 209/170

(57) ABSTRACT

A dispersion nozzle for dispersing a liquid with a gas, has a gas feed nozzle and a tubular mixing arrangement which has an inlet zone for the gas and the liquid and an outlet zone for a gas/liquid mixture. The mixing arrangement adjoins the gas feed nozzle. The gas feed nozzle is tapered in the direction of the mixing arrangement and opens into the inlet zone. The mixing arrangement has at least one liquid intake opening in the inlet zone. In the inlet zone a ratio of a diameter DG of a gas outlet opening of the gas feed nozzle and an internal diameter DM of the mixing arrangement is in the range from 1:3 to 1:5. A gas regulating valve meters a quantity of the gas being supplied with the gas feed nozzle. The dispersion nozzle may be used in a flotation machine.

### CROSS REFERENCE TO RELATED APPLICATIONS

This application is based on and hereby claims priority to International Application No. PCT/EP2012/066836 filed on Aug. 30, 2012 and European Application No. 11182473.6 filed on Sep. 23, 2011, the contents of which are hereby incorporated by reference.

### BACKGROUND

The invention relates to a dispersion nozzle for dispersing a liquid with at least one gas, said dispersion nozzle comprising a gas feed nozzle and a tubular mixing arrangement which has an inlet region for the at least one gas and the liquid and an outlet region for a gas/liquid mixture formed from the at least one gas and the liquid, as well as a method for operating the dispersion nozzle.

The invention also relates to a flotation machine equipped with at least one such dispersion nozzle, a method for operating the flotation machine and its use.

Dispersion nozzles of the type mentioned in the introduction are already used in flotation machines, see DE 32 11 906 C2 or CA 2 462 740 A1.

GB 355,211 discloses a flotation method with which a dispersion nozzle is used into which air is introduced, with suspension being sucked into the dispersion nozzle.

Flotation is a physical separation method for separating fine-grained mixtures of solid materials, from ores and gangue for example, in an aqueous suspension with the aid of air bubbles based on a different surface wettability of the particles contained in the suspension. It is used to prepare natural resources and during the processing of preferably mineral materials with a low to medium content of a useful component or valuable material, for example in the form of non-ferrous metals, iron, rare earth metals and/or precious metals and non-metallic natural resources.

Flotation machines are already sufficiently known. WO 2006/069995 A1 describes a flotation machine with a housing which encloses a flotation chamber, with at least one dispersion nozzle, referred to here as an ejector, and with at least one gas introduction facility, referred to as aeration facilities or aerators when air is used, as well as a collection vessel for a foam product formed during flotation.

During flotation or pneumatic flotation a suspension, which is usually made up of water and fine-grained solid material and contains reagents, is generally introduced into a flotation chamber. The reagents are to cause in particular the valuable particles in the suspension which are preferably to be separated out, to be configured in a hydrophobic manner. Gas, in particular air or nitrogen, is fed to the at least one dispersion nozzle at the same time as a suspension and comes into contact with the hydrophobic particles in the suspension. A gas introduction facility is used to introduce further gas into the suspension. The hydrophobic particles adhere to forming gas bubbles so that the gas bubble structures, also referred to as aeroflocks, float up and form the foam product on the surface of the suspension. The foam product is removed into a collection vessel and usually concentrated further.

It has been demonstrated that the quality of the foam product or the separation success of the flotation or pneumatic flotation method is a function inter alia of the probability of collision between a hydrophobic particle and a gas bubble. The greater the probability of collision, the greater the number of hydrophobic particles that adhere to a gas bubble, rise to the surface and form the foam product together with the particles. The probability of collision here is influenced inter alia by the dispersion of suspension and gas in a dispersion nozzle.

In the field of flotation units dispersion nozzles are not only used to feed a mixture in the form of gas and suspension to a flotation chamber. They are also used to disperse liquids without or with a very small proportion of solid material with gas and to inject the mixture into the liquid or suspension contained in the flotation machine.

There is a continuous demand for the most wear-resistant facilities possible for introducing gas into liquids, in particular suspensions, with which particularly small gas bubbles can be generated.

### SUMMARY

One potential object is to provide a further dispersion nozzle in order to increase a proportion of gas bubbles in a liquid and also a method for operating such a dispersion nozzle.

Another potential object is to specify a flotation machine with a higher yield and a method for its operation.

The inventors propose a dispersion nozzle for dispersing a liquid, in particular a suspension, also with at least one gas, said dispersion nozzle comprising a gas feed nozzle and a tubular mixing arrangement, which has an inlet region for the at least one gas and the liquid and an outlet region for a gas/liquid mixture formed from the at least one gas and the liquid, the mixing arrangement adjoining the gas feed nozzle, the gas feed nozzle tapering in the direction of the mixing arrangement and opening into its inlet region, the mixing arrangement having at least one intake opening for the liquid in the inlet region, a ratio of a diameter D_{G} of a gas outlet opening of the gas feed nozzle and an internal diameter D_{M} of the mixing arrangement in the inlet region being in the range from 1:3 to 1:5, and at least one gas regulating valve for metering a quantity of the at least one gas to be fed into the liquid being assigned to the gas feed nozzle.

The proposed dispersion nozzle allows intensive introduction of gas into a liquid, in particular a suspension, it being possible to generate particularly small gas bubbles with diameters of<1 mm with little wear. In particular it is possible to introduce gas into a liquid or suspension already present in a vessel or the like. In this process the liquid, in particular suspension, is sucked into the interior of the mixing arrangement by way of the intake opening(s). There is then advantageously no need for pumps, which convey the liquid, in particular suspension, into the mixing arrangement under pressure.

The intensive mixing of gas and liquid within the mixing arrangement of the dispersion nozzle is comparable to mixing in a conventional dispersion nozzle, by way of which however both gas and liquid are fed. The dispersion nozzle allows an increase in the proportion of gas without at the same time increasing the proportion of liquid into which the gas is to be introduced. The dispersion nozzle is therefore suitable in particular for achieving an increase in the probability of collision between gas bubbles and hydrophobic particles in flotation machines.

When the gas is dispersed with a suspension, the structure of the dispersion nozzle means that wear is greatly reduced compared with conventional dispersion nozzles, by way of which suspension and gas are fed to a flotation machine at the same time at high pressure, in particular in the region of the suspension infeed point. It is possible, with the dispersion nozzle, to dispense completely with the wear-prone pumps that were required until now to feed suspension and gas to a flotation machine at the same time at high pressure.

According to one aspect of the proposal, a ratio of a diameter D_{G} of a gas outlet opening of the gas feed nozzle and an internal diameter D_{M} of the mixing arrangement in the inlet region of the mixing arrangement is in the range from 1:3 to 1:5, in particular in the range from 1:3 to 1:3.5.

The resulting significant expansion of the gas in the mixing arrangement causes a particularly intensive mixing of the gas with the liquid, in particular suspension, to be achieved.

At least one gas regulating valve for metering a quantity of the at least one gas to be fed into the liquid is assigned to the gas feed nozzle, in order to be able to influence the ratio of gas and liquid in the mixing arrangement and the speed of the gas in the region of the gas outlet opening.

It is advantageous if the mixing arrangement is divided successively from the gas feed nozzle into a mixing chamber, which comprises the inlet region, a mixing tube and also a diffuser, the diffuser diameter of which increases from the mixing tube and which comprises the outlet region. The mixing chamber has the at least one intake opening for liquid, in particular suspension, here.

Alternatively the mixing arrangement can be divided successively from the gas feed nozzle into a mixing tube, which comprises the inlet region, and also a diffuser, the diffuser diameter of which increases from the mixing tube and which comprises the outlet region. The mixing tube has the at least one intake opening for liquid, in particular suspension, here.

A mechanical connection between the gas feed nozzle and the mixing chamber or mixing tube is preferably effected by at least one connecting element, which is disposed outside or on the periphery of the gas feed nozzle and the mixing arrangement.

For both embodiments an internal diameter of the mixing tube is either configured to be continuously the same size or tapers in the direction of the diffuser.

In one preferred embodiment the diffuser is configured as curved. This is advantageous in respect of the space requirement of the dispersion nozzle and results in the configuration of a swirling flow for the formed gas/liquid mixture, which further improves the dispersion of gas and liquid.

A ratio of a diameter D_{MR} of a mixing tube inlet opening of the mixing tube and a length L_{MR} of the mixing tube is preferably in the range from 1:3 to 1:8, in particular in the range from 1:4 to 1:6.

In one preferred embodiment of the dispersion nozzle only one intake opening is present in the inlet region of the mixing arrangement.

In an alternative embodiment the inlet region of the mixing arrangement has at least a number N≧2, in particular N≧8, of intake openings, by way of which liquid, in particular suspension, can be sucked into the interior of the mixing arrangement. This allows a more regular and rapid mixing of the liquid with the gas flowing out of the gas feed nozzle.

Intake openings here are preferably configured with a circular, rectangular or slot-type contour. A hole diameter of circular intake openings is preferably configured as a function of the wall thickness of the mixing arrangement in the inlet region. In particular the hole diameter is selected so that it is greater than or equal to the wall thickness.

The intake opening(s) is/are preferably disposed perpendicular to a longitudinal center axis of the dispersion nozzle but an arrangement at an angle to the longitudinal center axis is alternatively also possible. This ensures particularly intensive mixing of liquid, in particular suspension, and also gas, with particularly small bubbles being generated.

A number of intake openings are preferably disposed at a regular distance from one another on at least one circular path centered around the longitudinal center axis of the dispersion nozzle, in order to achieve the most regular feeding possible of liquid into the gas from all sides.

The gas feed nozzle, which tapers in the direction of the mixing arrangement, preferably has an internal wall, which is aligned at an angle α in the range from 3° to 15°, in particular at an angle α in the range from 4° to 6°, to the longitudinal center axis of the dispersion nozzle. The speed of the gas and the gas pressure in the region of the gas outlet opening are increased as a result.

The dispersion nozzle is preferably used to introduce gas into liquids such as water, waste water, process water, etc. An dispersion nozzle is used in particular to introduce gas into liquids in the form of suspensions during flotation processes.

The object is also achieved by a method for operating an dispersion nozzle, in that at least one gas is conducted into the mixing arrangement by way of the gas feed nozzle, in that liquid, in particular suspension, is sucked into the interior of the mixing arrangement by way of the at least one intake opening, in that a gas/liquid mixture is formed in the mixing arrangement and gas is fed in by way of the gas feed nozzle in such a manner that the at least one gas is present at a gas outlet opening of the gas feed nozzle with a pulsed flow density in the range from 5*10³ to 5*10⁴ kg/(m*s²).

This allows a particularly intensive and regular dispersion of gas and liquid to be achieved, with a preferred bubble diameter of<1 mm predominantly being attained in the dispersed gas.

The pulsed flow density is preferably in the range from 1*10⁴ to 5*10⁴ kg/(m*s²), but in particular in the range from 3*10⁴ to 5*10⁴ kg/(m*s²).

It has been demonstrated to be favorable for the method if the mixing arrangement comprises a mixing tube, for a shear rate in the range from 500 to 5000 l/s, in particular from 1000 to 1500 l/s, to be present for the gas/liquid mixture at a mixing tube outlet opening. The higher the shear rate, the smaller the gas bubbles generated in the gas/liquid mixture. This improves the dispersion of gas and liquid still further.

The object is achieved for the flotation machine in that it comprises at least one dispersion nozzle. The use of one or more dispersion nozzles on a flotation machine enables intensive mixing of gas into a liquid, in particular a suspension, which is already present in the flotation machine, without introducing further liquid into the flotation machine by way of the dispersion nozzle(s). This allows the proportion of gas in the liquid, in particular the suspension, to be increased significantly. The probability of collision between a gas bubble and a particle to be separated out of a suspension increases and the yield is greater.

In one preferred embodiment the flotation machine comprises a housing with a flotation chamber, into which the at least one dispersion nozzle opens.

The mixing arrangement, including the at least one intake opening, is disposed here in particular in the flotation chamber, so that liquid, in particular suspension, washes around the mixing arrangement and liquid can pass easily through the intake opening(s) and into the interior of the mixing arrangement without any auxiliary structures. This results in enrichment of the gas in the liquid contained in the flotation chamber without increasing or diluting said liquid.

Alternatively the mixing arrangement can also be disposed outside the flotation chamber, with the result that liquid has to be fed to the intake opening(s), for example by way of an additional tube line or similar. Liquid in the form of water, process water, suspension, etc., in particular suspension, can be conducted out of the flotation chamber to the intake openings here. In the case of dispersion of water or process water with the gas and injection into the flotation chamber of a flotation machine containing a suspension, the suspension is of course diluted by the additional water or process water. In the case of dispersion of further suspension with the gas and injection into the flotation chamber of a flotation machine containing a suspension, the suspension is of course increased by the further suspension. The achievable number of gas bubbles per unit of volume of liquid is therefore smaller for such instances.

The object is achieved for a method for operating an flotation machine in that the flotation chamber is filled with liquid, in particular suspension, in such a manner that the at least one intake opening of the at least one dispersion nozzle is below a surface formed by the liquid, in particular the suspension.

The at least one dispersion nozzle present is preferably operated according to the method described above for operating the dispersion nozzle.

The flotation chamber is filled in particular with a suspension with a solid material content in the range from 30 to 60%. Such solid material contents in suspensions are standard in particular for the flotation of minerals containing ore.

The use of an flotation machine for separating an ore from gangue has therefore been demonstrated to be favorable. However the flotation machine can also be used in other ways, for example for the flotation of waste water, suspensions containing minerals that do not contain ore, e.g. carboniferous rocks, etc.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a longitudinal section of a first dispersion nozzle;

FIG. 2 shows an enlarged section from the first dispersion nozzle in the region of the gas feed nozzle;

FIG. 3 shows the operating principle of a dispersion nozzle with curved diffuser;

FIG. 4 shows a side view of a second dispersion nozzle with curved diffuser;

FIG. 5 shows a partial longitudinal section of a flotation machine with a dispersion nozzle.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

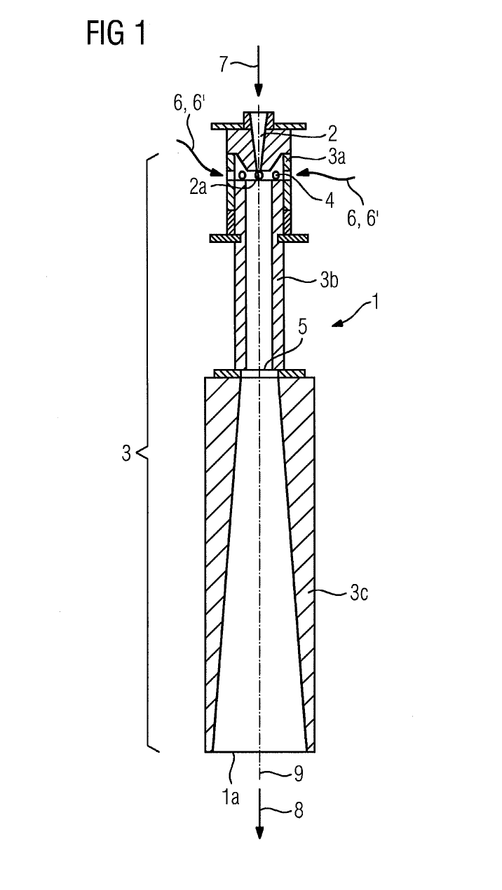

FIG. 1 shows a longitudinal section of a first dispersion nozzle 1 for dispersing a liquid 6, in particular a suspension 6′, also with at least one gas 7. The first dispersion nozzle 1 comprises a gas feed nozzle 2 with a gas outlet opening 2a and a tubular mixing arrangement 3, which has an inlet region for the at least one gas 7 and the liquid 6 or suspension 6′ and an outlet region 1a for a gas/liquid mixture 8 formed from the at least one gas 7 and the liquid 6 or suspension 6′. Disposed upstream of the gas feed nozzle 2 is at least one gas regulating valve (not shown here for the sake of clarity) for metering a quantity of the gas 7 to be fed into the liquid 6. The mixing arrangement 3 adjoins the gas feed nozzle 2. The gas feed nozzle 2 tapers in the direction of the mixing arrangement 3 and opens into its inlet region. The mixing arrangement 3 also has a number of intake openings 4 for the liquid 6 or suspension 6′ in the inlet region. The intake openings 4 here are disposed perpendicular to a longitudinal center axis 9 of the first dispersion nozzle 1. In this embodiment the mixing arrangement 3 is divided successively from the gas feed nozzle 2 into a mixing chamber 3a, which comprises the inlet region, a mixing tube 3b with a mixing tube outlet opening 5 and also a diffuser 3c, the diffuser diameter of which increases from the mixing tube 3b and which comprises the outlet region 1a. The mixing chamber 3a and the mixing tube 3b can however equally be configured as a single piece. Alternatively the mixing tube 3b and the diffuser 3c or the mixing chamber 3a, the mixing tube 3b and the diffuser 3c can also be configured as a single piece.

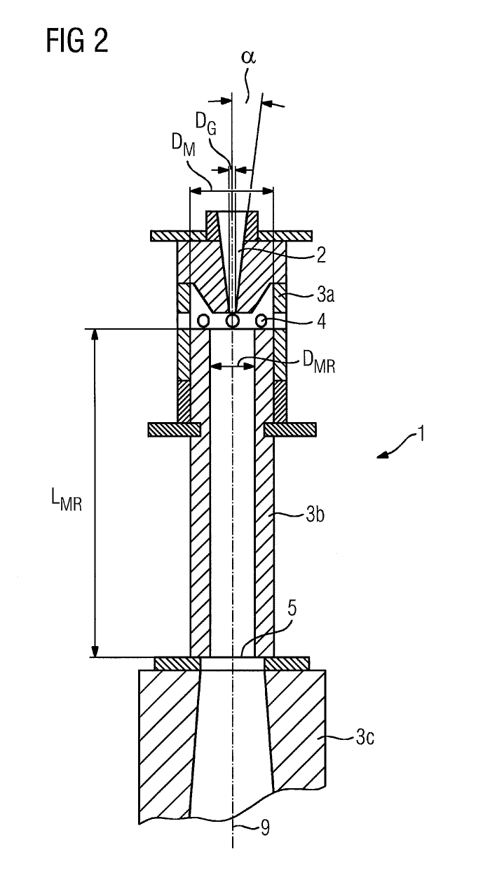

FIG. 2 shows an enlarged section from the first dispersion nozzle 1 according to FIG. 1 in the region of the gas feed nozzle 2. Identical reference characters to those in FIG. 1 denote identical elements. The gas feed nozzle 2 here has an internal wall, which is aligned at an angle α of 4° to the longitudinal center axis 9 of the first dispersion nozzle 1. A ratio of a diameter D_{G} of the gas outlet opening 2a of the gas feed nozzle 2 and an internal diameter D_{M} of the mixing arrangement 3 in the inlet region, in this instance also the internal diameter of the mixing chamber 3a, is around 1:3 to 1:5 here.

A ratio of a diameter D_{MR} of a mixing tube inlet opening of the mixing tube 3b and a length L_{MR} of the mixing tube 3b is around 1:5 here.

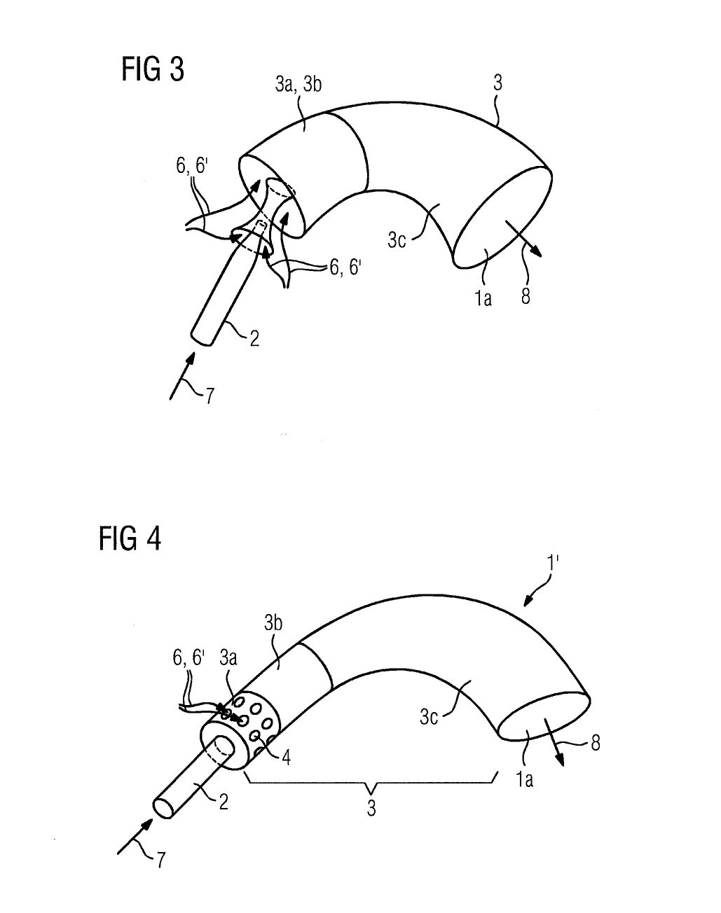

FIG. 3 shows the operating principle of a dispersion nozzle with a mixing arrangement 3 with curved diffuser 3c. Identical reference characters to those in FIG. 1 denote identical elements. A curved diffuser 3c reduces the dimensions of the dispersion nozzle and allows it to be used even in restricted spatial conditions. A swirling movement is imposed on the gas/liquid mixture 8 formed, resulting in a further improvement in the dispersion of gas 7 and liquid 6 or suspension 6′.

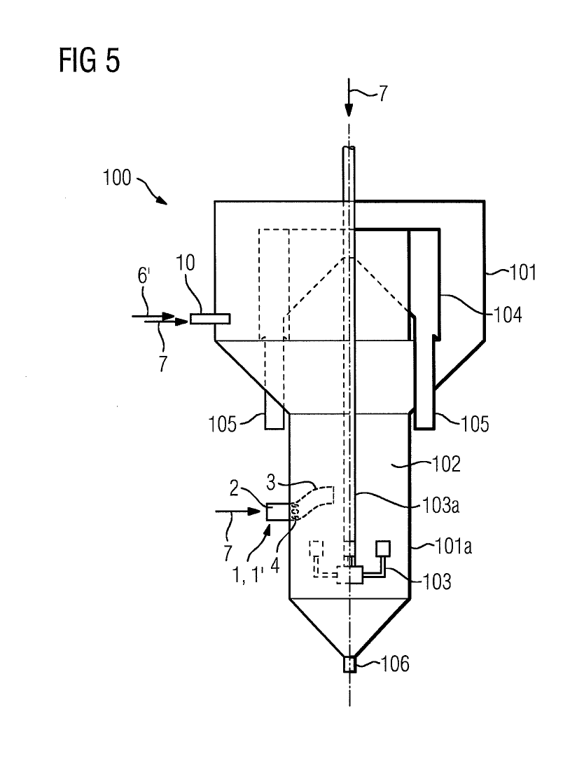

FIG. 4 shows a side view of a second dispersion nozzle 1′ with curved diffuser 3c. Identical reference characters to those in FIGS. 1 and 3 denote identical elements.

FIG. 5 shows a partial longitudinal section of a flotation machine 100 with a structure that is known per se, the right half being shown sliced through. The flotation machine 100 comprises a housing 101 with a flotation chamber 102, into which at least one conventional dispersion nozzle 10 opens to feed gas 7 and suspension 6′ into the flotation chamber 102. Conventional dispersion nozzles 10 are generally incorporated in such a manner that the longitudinal axis of the dispersion nozzle(s) 10 is aligned horizontally. The housing 101 has a cylindrical housing segment 101a, on the lower end of which a gas introduction arrangement 103 can optionally be disposed.

Present within the flotation chamber 102 is a foam channel 104 with connectors 105 for removing the formed foam product. The upper edge of the outer wall of the housing 101 is above the upper edge of the foam channel 104, thereby preventing the foam product overflowing over the upper edge of the housing 101. The housing 101 also has a bottom removal opening 106. Particles of the suspension 6′, which do not have a sufficiently hydrophobized surface for example or have not collided with a gas bubble, and hydrophilic particles sink in the direction of the bottom removal opening 106 and are removed. The foam product passes out of the flotation chamber 102 into the foam channel 104 and is carried away by way of the connectors 105 and optionally concentrated.

The incorporation of dispersion nozzles 1, 1′, by way of which only gas 7 is introduced into the flotation chamber 102 here, to be dispersed with suspension 6′ already present in the flotation chamber 102, is preferably effected here in such a manner that the longitudinal center axis 9 of the dispersion nozzle 1, 1′ is aligned horizontally. However an arrangement of dispersion nozzles 1, 1′ on the flotation machine 100 with the longitudinal center axis 9 at an angle to the horizontal is also possible.

The optional gas introduction facility 103, which adjoins a gas feed 103a, is optionally used to blow additional gas 7 into the cylindrical housing segment 101a, so that further hydrophobic particles are bound thereto and rise. Ideally the hydrophilic particles in particular continue to sink, being discharged by way of the bottom removal opening 106.

Using at least one dispersion nozzle 1, 1′, with a curved diffuser for example, in the flotation machine 100 improves the dispersion of suspension 6′ and gas 7 still further and thus increases the probability of collision between a gas bubble and a particle to be separated out of the suspension 6′. Improved separation rates and an optimum foam product can therefore be achieved. A curved structure of the mixing arrangement 3 as a whole is space-saving and can therefore also be used in an optimum manner in the interior of a flotation chamber with a small diameter.

However the use of an dispersion nozzle is not limited to a flotation machine generally or to a flotation machine with a structure according to FIG. 5. An dispersion nozzle can be used in flotation units of any structure or units in which at least one gas is to be distributed in a fine and regular manner in a liquid, in particular a suspension. The dispersion nozzle can of course therefore also be used independently of a preferred application in flotation machines to introduce gas into water, waste water, process water, etc.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-19. (canceled)

20. A dispersion nozzle for dispersing a liquid with a gas, the dispersion nozzle extending about a longitudinal center axis, the dispersion nozzle comprising:
a tubular mixing arrangement which has a common inlet region for the gas and the liquid and an outlet region for a gas/liquid mixture formed from the gas and the liquid, the inlet region having an internal diameter D_{M}, the mixing arrangement having at least 3 intake openings in the inlet region, for the liquid, the intake openings being disposed at an angle to the longitudinal center axis of the dispersion nozzle;
a gas feed nozzle adjoining the mixing arrangement, the gas feed nozzle tapering toward the mixing arrangement and having a gas outlet opening that opens into the inlet region of the mixing arrangement, the gas outlet opening having a diameter D_{G}, a ratio of the diameter D_{G} of the gas outlet opening to the internal diameter D_{M} of the inlet region of the mixing arrangement being from 1:3 to 1:5; and
a gas regulating valve to meter a quantity of the gas fed into the liquid via the gas feed nozzle.

21. The dispersion nozzle as claimed in claim 20, wherein
the mixing arrangement is divided into a mixing chamber, a mixing tube and a diffuser,
the inlet region is provided in the mixing chamber,
the outlet region is provided in the diffuser,
the mixing tube is provided between the mixing chamber and the diffuser, and
the diffuser has a diameter which increases from the mixing tube to the outlet region.

22. The dispersion nozzle as claimed in claim 21, wherein
the mixing tube has an inlet opening with a diameter D_{MR},
the mixing tube has a length L_{MR}, and
a ratio of the diameter D_{MR} of the mixing tube inlet opening to the length L_{MR} of the mixing tube being from 1:3 to 1:8.

23. The dispersion nozzle as claimed in claim 21, wherein the diffuser is curved.

24. The dispersion nozzle as claimed in claim 20, wherein
the mixing arrangement is divided into a mixing tube and a diffuser,
the inlet region is provided in the mixing tube,
the outlet region is provided in the diffuser, and
the diffuser has a diameter which increases from the mixing tube to the outlet region.

25. The dispersion nozzle as claimed in claim 24, wherein
the mixing tube has an inlet opening with a diameter D_{MR},
the mixing tube has a length L_{MR}, and
a ratio of the diameter D_{MR} of the mixing tube inlet opening to the length L_{MR} of the mixing tube being from 1:3 to 1:8.

26. The dispersion nozzle as claimed in claim 24, wherein the diffuser is curved.

27. The dispersion nozzle as claimed in claim 20, wherein at least 8 intake openings are provided in the inlet region.

28. The dispersion nozzle as claimed in claim 20, wherein
the intake openings are disposed at a regular distance from one another on at least one circular path centered around the longitudinal center axis of the dispersion nozzle.

29. The dispersion nozzle as claimed in claim 20, wherein
the gas feed nozzle has an internal wall, which is aligned at an angle α of from 3° to 15° to the longitudinal center axis of the dispersion nozzle.

30. The dispersion nozzle as claimed in claim 20, wherein
the gas feed nozzle has an internal wall, which is aligned at an angle α of from 4° to 6° to the longitudinal center axis of the dispersion nozzle.

31. The dispersion nozzle as claimed in claim 20, wherein the intake openings are round.

32. The dispersion nozzle as claimed in claim 31, wherein the intake openings have a hole diameter greater than or equal to a wall thickness of the mixing arrangement.

33. The dispersion nozzle as claimed in claim 20, wherein the intake openings are disposed perpendicular to the longitudinal center axis of the dispersion nozzle.

34. A method for operating a dispersion nozzle for dispersing a liquid with a gas, the dispersion nozzle extending about a longitudinal center axis, the dispersion nozzle comprising:
a tubular mixing arrangement which has a common inlet region for the gas and the liquid and an outlet region for a gas/liquid mixture formed from the gas and the liquid, the inlet region having an internal diameter D_{M}, the mixing arrangement having at least 3 intake openings in the inlet region, for the liquid, the intake openings being disposed at an angle to the longitudinal center axis of the dispersion nozzle;
a gas feed nozzle adjoining the mixing arrangement, the gas feed nozzle tapering toward the mixing arrangement and having a gas outlet opening that opens into the inlet region of the mixing arrangement, the gas outlet opening having a diameter D_{G}, a ratio of the diameter D_{G} of the gas outlet opening to the internal diameter D_{M} of the inlet region of the mixing arrangement being from 1:3 to 1:5; and
a gas regulating valve to meter a quantity of the gas fed into the liquid via the gas feed nozzle, the method comprising:
conducting the gas into the mixing arrangement by way of the gas feed nozzle, the gas being fed in such a manner that the gas is present at the gas outlet opening with a pulsed flow density in a range of from 5*10³ to 5*10⁴ kg/(m*s²);
sucking the liquid into the mixing arrangement by way of the intake openings; and
forming a gas/liquid mixture in the mixing arrangement.

35. The method as claimed in claim 34, wherein the pulsed flow density is in a range of from 1*10⁴ to 5*10⁴ kg/(m*s²).

36. The method as claimed in claim 35, wherein the pulsed flow density is in a range of from 3*10⁴ to 5*10⁴ kg/(m*s²).

37. The method as claimed in claim 34, wherein
the mixing arrangement has a mixing tube having a mixing tube outlet opening, and
a shear rate of from 500 to 5000 l/s is present for the gas/liquid mixture at the mixing tube outlet opening.

38. The method as claimed in claim 34, wherein
the mixing arrangement has a mixing tube having a mixing tube outlet opening, and
a shear rate of from 1000 to 1500 l/s is present for the gas/liquid mixture at the mixing tube outlet opening.

39. A flotation machine comprising at least one dispersion nozzle as claimed in claim 20.

40. The flotation machine as claimed in claim 39, wherein
the flotation machine has a housing with a flotation chamber, and
the at least one dispersion nozzle opens into the flotation chamber.

41. The flotation machine as claimed in claim 40, wherein the mixing arrangement, including the intake openings, is disposed in the flotation chamber.

42. The flotation machine as claimed in claim 40, wherein the longitudinal center axis of each dispersion nozzle is aligned horizontally with respect to a vertically extending flotation chamber.

43. A method for operating a flotation machine comprising a housing with a flotation chamber and at least one dispersion nozzle opening into the flotation chamber for dispersing a liquid with a gas, each dispersion nozzle extending about a longitudinal center axis, each dispersion nozzle comprising:
a tubular mixing arrangement which has a common inlet region for the gas and the liquid and an outlet region for a gas/liquid mixture formed from the gas and the liquid, the inlet region having an internal diameter D_{M}, the mixing arrangement having at least 3 intake openings in the inlet region, for the liquid, the intake openings being disposed at an angle to the longitudinal center axis of the dispersion nozzle;
a gas feed nozzle adjoining the mixing arrangement, the gas feed nozzle tapering toward the mixing arrangement and having a gas outlet opening that opens into the inlet region of the mixing arrangement, the gas outlet opening having a diameter D_{G}, a ratio of the diameter D_{G} of the gas outlet opening to the internal diameter D_{M} of the inlet region of the mixing arrangement being from 1:3 to 1:5; and
a gas regulating valve to meter a quantity of the gas fed into the liquid via the gas feed nozzle, the method comprising:
filling the flotation chamber with liquid or a solid-liquid suspension, in such a manner that the intake openings of the at least one dispersion nozzle are below a surface formed by the liquid or the solid-liquid suspension.

44. The method as claimed in claim 43, further comprising feeding the gas by way of the gas feed nozzle such that the gas is present at the gas outlet opening with a pulsed flow density in a range of from 5*10³ to 5*10⁴ kg/(m*s²).

45. The method as claimed in claim 43, wherein
the flotation chamber is filled with the solid-liquid suspension, and
the solid-liquid suspension has a solid material content of from 30 to 60%.

46. The method as claimed in claim 45, further comprising separating suspended ore from gangue.
